(19) United States
(12) Patent Application Publication
(10) Pub. No.: US 2011/0235225 A1
(43) Pub. Date: Sep. 29, 2011

(54) OVERCURRENT PROTECTION CIRCUIT

(75) Inventor: HAI-QING ZHOU, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/790,971

(22) Filed: May 31, 2010

(30) Foreign Application Priority Data
Mar. 25, 2010 (CN) 201010132347.3

(51) Int. Cl. H02H 3/08

(52) U.S. Cl. 361/93.7

(57) ABSTRACT

An overcurrent protection circuit includes an operational amplifier, a first resistor, a second resistor, and a switch. A non-inverting input of the operational amplifier is connected to an output of a power supply circuit and an inverting input of the operational amplifier is connected to a first terminal of a load of the power supply circuit. A second terminal of the load is grounded. The first and second resistors are connected in parallel and coupled between the inverting input and the non-inverting input of the operational amplifier. The switch is coupled to an enable terminal of the power supply circuit and coupled to an output of the operational amplifier.

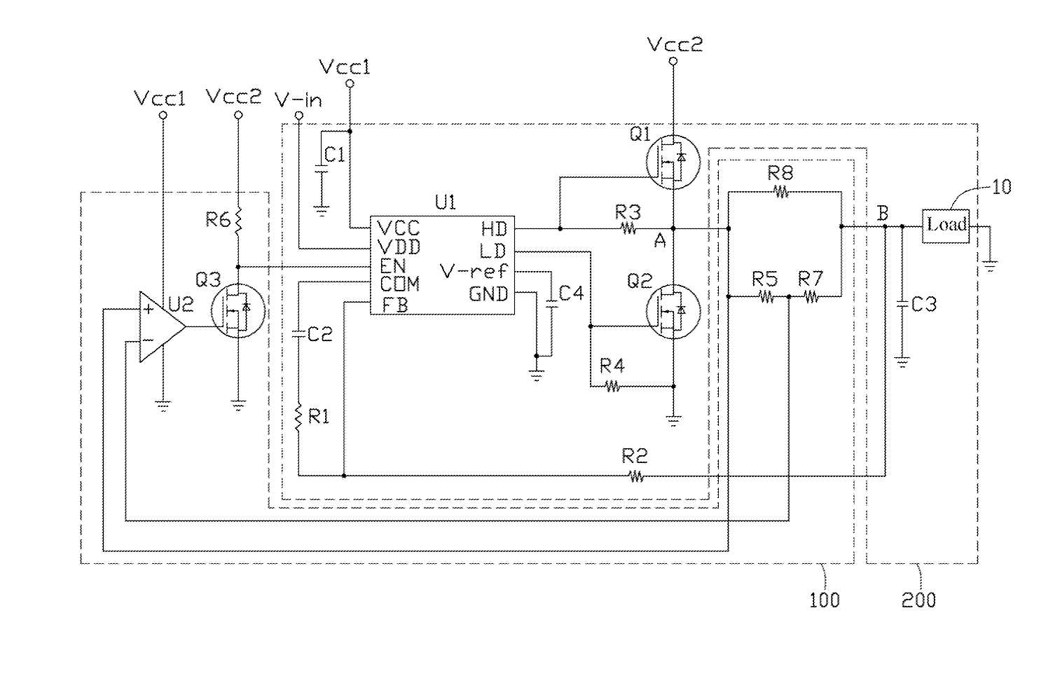

### BACKGROUND

1. Technical Field

The present disclosure relates to overcurrent protection circuits.

2. Description of Related Art

Some power supply circuits, such as front side bus (FSB) termination circuits, have no overcurrent protection circuits to protect power supply circuits from overcurrent loads. When the outputs of the power supply circuits receive an overcurrent, the loads of the power supply circuits may burned out.

### BRIEF DESCRIPTION OF THE DRAWING

Many aspects of the present embodiments can be better understood with reference to the following drawing. The components in the drawing are not necessarily drawn to scale, the emphasis instead being placed upon clearly illustrating the principles of the present embodiments. Moreover, in the drawing, all the views are schematic, and like reference numerals designate corresponding parts throughout the several views.

The FIGURE is a circuit diagram of an exemplary embodiment of an overcurrent protection circuit.

### DETAILED DESCRIPTION

The disclosure, including the accompanying drawings is illustrated by way of example and not by way of limitation. It should be noted that references to “an” or “one” embodiment in this disclosure are not necessarily to the same embodiment, and such references mean at least one.

Referring to the FIGURE, an exemplary embodiment of an overcurrent protection circuit 100 is used to protect a load 10 of a termination circuit 200.

The termination circuit 200 includes a voltage adjustor U1, a first metal-oxide-semiconductor field effect transistor (MOSFET) Q1, a second MOSFET Q2, resistors R1-R4, and capacitors C1-C4.

The voltage adjustor U1 includes a power terminal VCC, a ground terminal GND, an enable terminal EN, a voltage input terminal VDD, a reference voltage terminal V-ref, a feed back terminal FB, a compensation terminal COM, a high-side drive terminal HD, and a low-side drive terminal LD.

The power terminal VCC of the voltage adjustor U1 is connected to a first power supply Vcc1, and to a first terminal of the capacitor C1. A second terminal of the capacitor C1 is grounded. The voltage input terminal VDD is coupled to a second power supply V-in. The compensation terminal COM is connected to the feed back terminal FB via the capacitor C2 and the resistor R1 in series. The feed back terminal FB is grounded via the resistor R2 and the capacitor C3 in series. The high-side drive terminal HD is coupled to a gate of the first MOSFET Q1. The low-side drive terminal LD is coupled to a gate of the second MOSFET Q2. The reference voltage terminal V-ref is connected to a first terminal of the capacitor C4. A second terminal of the capacitor C4 is grounded. The ground terminal GND is grounded.

A drain of the first MOSFET Q1 is coupled to a third power supply Vcc2. A source of the first MOSFET Q1 is connected to the high-side drive terminal HD of the voltage adjustor U1 via the resistor R3. A drain of the second MOSFET Q2 is coupled to the source of the first MOSFET Q1. A source of the second MOSFET Q2 is grounded, and is connected to the low-side drive terminal LD of the voltage adjustor U1 via the resistor R4.

The voltage adjustor U1 controls the first MOSFET Q1 and the second MOSFET Q2 to turn on or off. The node A between the source of the first MOSFET Q1 and the drain of the second MOSFET Q2 outputs a first voltage. The node B between the capacitor C3 and the resistor R2 is coupled to a first terminal of the load 10. A second terminal of the load 10 is grounded. The third power supply Vcc2 supplies power to the load 10 via the first MOSFET Q1.

The overcurrent protection circuit 100 includes an operational amplifier U2, a third MOSFET Q3, and resistors R5-R8.

A non-inverting input of the operational amplifier U2 is coupled to the node A. An inverting input of the operational amplifier U2 is connected to the non-inverting input of the operational amplifier U2 via the resistor R5. An output of the operational amplifier U2 is coupled to a gate of the third MOSFET Q3. A power terminal of the operational amplifier U2 is coupled to the first power source Vcc1. A ground terminal of the operational amplifier U2 is grounded.

A drain of the third MOSFET Q3 is connected to the third power supply Vcc2 via the resistor R6, and is coupled to the enable terminal EN of the voltage adjustor U1. A source of the third MOSFET Q3 is grounded.

A first terminal of the resistor R5 is coupled to the node A. A second terminal of the resistor R5 is connected to the inverting terminal of the operational amplifier U2, and is connected to the node B via the resistor R7. A first terminal of the resistor R8 is coupled to the node A. A second terminal of the resistor R8 is coupled to the node B. The resistances of the resistors R5 and R7 are considerably larger than the resistance of the resistor R8. In one embodiment, the resistance of the resistor R8 is 0.3 ohms (Ω) and the resistances of the resistors R5 and R7 are both 30 kilo ohms (KΩ) each.

The current flowing through the resistors R5 and R7 is negligible because the resistances of the resistors R5 and R7 are considerably larger than the resistance of the resistor R8. The first voltage of the node A is approximately equal to the voltage of the node B because the resistance of the resistor R8 is considerably smaller then R5 and R7.

When the current flowing through the resistor R8 is normal, the voltage across the resistor R5 is less than the offset voltage of the operational amplifier U2. The operational amplifier U2 does not work. The third MOSFET Q3 is turned off. The drain of the third MOSFET Q3 is at a high voltage level. The enable terminal EN of the voltage adjustor U1 is at a high voltage level, and the voltage adjustor U1 keeps working.

When the current flowing through the resistor R8 is in an overcurrent condition, the voltage across the resistor R5 is larger than the offset voltage of the operational amplifier U2. The output of the operational amplifier U2 is at a high voltage level. The third MOSFET Q3 is turned on and the drain of the third MOSFET Q3 is at a low voltage level. The enabled terminal EN of the voltage adjustor U1 is at a low voltage level, and the voltage adjustor U1 stops working. The termination circuit 200 does not output any voltage.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An overcurrent protection circuit, comprising:
an operational amplifier, wherein a non-inverting input of the operational amplifier is coupled to an output of a power supply circuit and an inverting input of the operational amplifier is connected to a first terminal of a load of the power supply circuit, a second terminal of the load is grounded;
first and second resistors connected in parallel and coupled between the inverting input and the non-inverting input of the operational amplifier; and
a switch coupled to an enable terminal of the power supply circuit and coupled to an output of the operational amplifier;
wherein when current flowing through the second resistor is in an overcurrent state, the voltage across the first resistor is larger than an offset voltage of the operational amplifier, the output of the operational amplifier is at a high voltage level, the switch is turned on, the enable terminal of the power supply circuit is at a low voltage level, and the power supply circuit stops working.

2. The overcurrent protection circuit of claim 1, wherein the resistance of the first resistor is considerably larger than the resistance of the second resistor.

3. The overcurrent protection circuit of claim 1, further comprising a capacitor, wherein the second terminal of the second resistor is coupled to a first terminal of the capacitor, a second terminal of the capacitor is grounded.

4. The overcurrent protection circuit of claim 1, wherein the switch is a metal-oxide-semiconductor field effect transistor (MOSFET), a drain of the MOSFET is connected to a power supply via a third resistor, and coupled to the enable terminal of the power supply circuit, a gate of the MOSFET is coupled to the output of the operational amplifier, a source of the MOSFET is grounded.
